(19) United States
(12) Patent Application Publication
(10) Pub. No.: US 2013/0222360 A1
(43) Pub. Date: Aug. 29, 2013

(54) SYNCHRONOUS AND ASYMMETRICAL DISPLAY SYSTEM AND METHOD OF OPERATING THE SAME

(71) Applicants: Chih-Ping Tsai, New Taipei City (TW); Ming-Jen Tsai, New Taipei City (TW)

(72) Inventors: Chih-Ping Tsai, New Taipei City (TW); Ming-Jen Tsai, New Taipei City (TW)

(21) Appl. No.: 13/618,069

(22) Filed: Sep. 14, 2012

(30) Foreign Application Priority Data
Feb. 24, 2012 (TW) 101106379

(51) Int. Cl. G06F 3/038

(52) U.S. Cl. 345/213

(57) ABSTRACT

A synchronous and asymmetrical display system and a method of operating the same are disclosed herein, where the synchronous and asymmetrical display system includes a single power module, a set of synchronous transmission lines, and display modules connected in series through the set of synchronous transmission lines, in which each display module includes a receive unit. This method includes the steps as follows. The first step is to command each display module to search a signal command from its receive unit and the set of synchronous transmission lines. Then, when one of the display modules acquire the power switch signal, the power switch signal is transmitted to the other display modules through the set of synchronous transmission lines, and one of the display modules generates a power control signal to control the power module.

### CROSS-REFERENCE TO RELATED APPLICATIONS

This application claims priority to Taiwan Application Serial Number 101106379, filed Feb. 24, 2012, which is herein incorporated by reference.

### BACKGROUND OF THE INVENTION

1. Field of the Invention

The present disclosure relates to display systems with operation methods, and more particularly, a synchronous and asymmetrical display system and a method of operating the same.

2. Description of Related Art

Displays in an indoor or outdoor place for playing, video, text or anther information have become more popular. Particularly, the systematic and large-scale displays are usually disposed in public places for displaying advertisement. In conventional art, two independent displays can be integrated into a multi-display device by complex processes, and thus a processing time and cost are increased adversely. In practice, two independent displays are disassembled for removing a backlight module from one of the two independent displays, then these two displays are combined to share the other backlight module, and finally display systems of these two displays are integrated. However, this method can only manufacture a double-sided display without expandability, and the processing to disassemble displays may result in damages, and therefore ineffective in synchronous operation.

In view of the foregoing, there exist problems and disadvantages in the current multi-display device techniques that await further improvement. However, those skilled in the art sought vainly for a solution. In order to solve or circumvent above problems and disadvantages, there is an urgent need in the related field to improve the synchronous operation.

### SUMMARY OF THE INVENTION

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more aspects, the present invention is directed to a synchronous and asymmetrical display system and a method of operating the same, so as to improve the synchronous operation.

According to one embodiment of the present invention, a synchronous and asymmetrical display system includes a set of synchronous transmission lines, a plurality of display modules and a single power module. The display modules are connected in series through the set of synchronous transmission lines. The power module is electrically connected to the display modules, and each display module includes a receiving unit, a display panel and a control unit. The control unit is electrically connected to the display panel and the receiving unit for searching a signal command from the receiving unit and the set of synchronous transmission lines. When one of the control units acquires the signal command, the one of the control units transmits the signal command to the other control units through the set of synchronous transmission lines, and then one of the display modules generates a power control signal to control the power module.

When the power module is connected to a commercial power, the control units set initial statuses of the display panels respectively and then search the signal command from the receiving unit and the set of synchronous transmission lines periodically. When the power module is disconnected from the commercial power, each of the control units stops searching the signal command.

The display modules acquire video signals respectively, so that the display panels display images based on the video signals respectively.

The receiving unit includes a wireless receiver for receiving the signal command.

Alternatively or additionally, the receiving unit includes a transmission port for receiving the signal command.

Alternatively or additionally, the receiving unit includes a manual switch for sending the signal command.

According to another embodiment of the present invention, a method of operating a synchronous and asymmetrical display system that includes a set of synchronous transmission lines, display modules and a single power module. The display modules connected in series through the set of synchronous transmission lines, and the display modules includes a receiving unit each. The method includes steps as follows. The step (a) is to command each of the display modules to search a signal command from its receiving unit and the set of synchronous transmission lines. In step (b), when one of the display modules acquires the signal command, the signal command is transmitted to the other display modules through the set of synchronous transmission lines, and then a power control signal is generated by one of the display modules to control the power module.

In step (a), initial statuses of the display modules are set respectively when the power module is connected to a commercial power, and then each of the display modules is used for searching the signal command from the receiving unit and the set of synchronous transmission lines periodically; and searching the signal command is stopped when the power module stops supplying an alternate current for the display modules.

The method further includes step (c). In step (c), when the display modules acquire video signals respectively, images based on the video signals are displayed respectively.

In the method, the receiving unit may include a wireless receiver, a transmission port and a manual switch.

Technical advantages are generally achieved, by embodiments of the present invention, as follows:

1. The plurality of display modules share a single power module, so as to reduce cost and volume; and

2. The set of synchronous transmission lines are connected to each individual display module for accomplishing synchronicity, consistency and expandability without additional circuitry.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a synchronous and asymmetrical display system according to one embodiment of the present disclosure;

FIG. 2 is a flowchart of a method of operating a synchronous and asymmetrical display system according to another embodiment of the present disclosure; and

FIG. 3 is a schematic drawing of a synchronous and asymmetrical display system according to yet another embodiment of the present disclosure.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

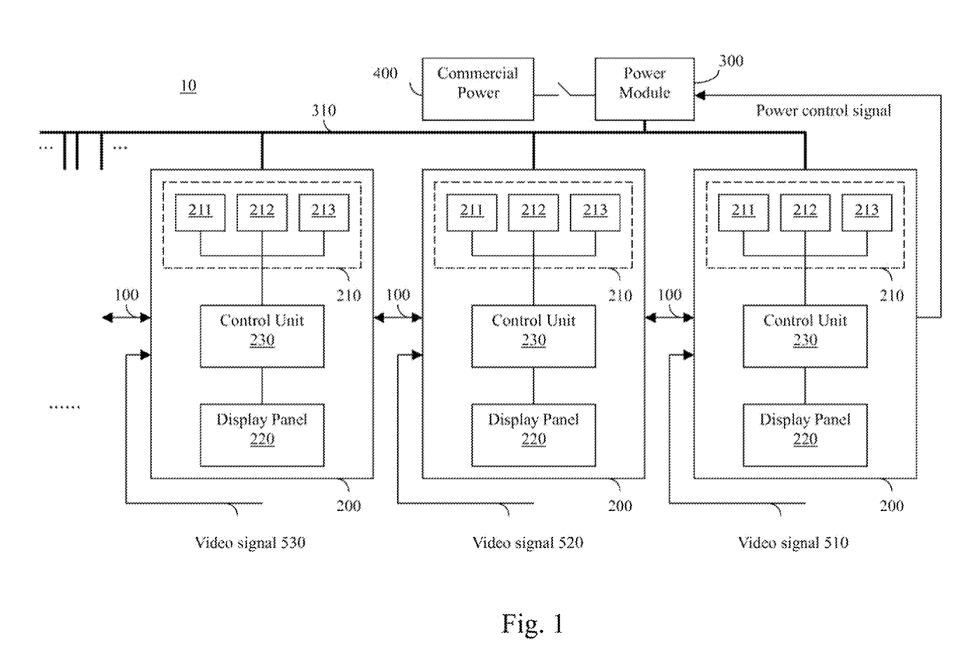

In one or more various aspects, the present invention is directed to a synchronous and asymmetrical display system. This system may be easily configured in an indoor or outdoor place for playing, video, text or anther information, and may be applicable or readily adaptable to all related technology. It should be noted that in this system a plurality of display modules share a single power module. For a more complete understanding of a synchronous and asymmetrical display system 10, and the advantages thereof, please refer to FIG. 1 and embodiments of the present disclosure.

FIG. 1 is a block diagram of the synchronous and asymmetrical display system 10 according to one embodiment of the present disclosure. As shown in FIG. 1, the synchronous and asymmetrical display system 10 includes a set of synchronous transmission lines 100, a plurality of display modules 200 and a single power module 300. The display modules 300 are connected in series through the set of synchronous transmission lines 100. The power module 300 is electrically connected to the display modules 200. In practice, the power module 300 may be a power board.

In this embodiment, the power module 300 is connected to the display modules 200 via the power line 310. In use, when the power module 300 is connected to a commercial power 400, the power module 300 can supply electric power for the display modules 200.

The synchronous and asymmetrical display system 10 is utilized to reduce cost and volume and to simplify circuitry, mechanism and processing. In operation, each display module can have an individual control signal. The display modules 200 share a single power module 300, so that the power module 300 can supply electric power for the display modules 200. Furthermore, the set of synchronous transmission lines 100 are connected to each individual display module 200 for accomplishing synchronicity, consistency and expandability without additional circuitry.

In FIG. 1, each display module 200 includes a receiving unit 210, a display panel 220 and a control unit 230. The control unit 230 is electrically connected to the display panel 220 and the receiving unit 210. In use, the control unit 230 searches a signal command from the receiving unit 210 and the set of synchronous transmission lines 100. When one of the control units 230 acquires the signal command, the one of the control units 230 transmits the signal command to the other control units 230 through the set of synchronous transmission lines 100 asymmetrically, and then one of the display modules 200 generates a power control signal to control the power module 300.

In this way, a user can input the signal command, and the display modules 200 operate synchronously according to the signal command. For example, when the signal command is a shutdown signal, the display modules 200 is turned off according to the shutdown signal, and the power module 300 stops supplying electric power for the display modules 200 according to the shutdown signal; on the contrary, when the signal command is a boot signal, the display modules 200 is turned on according to the boot signal, and the power module 300 supplies electric power for the display modules 200 according to the boot signal. Accordingly, pluralities of individual display modules 200 integrated in the synchronous and asymmetrical display system 10 are effective in synchronous operation, so as to reduce cost and volume, and to facilitate the user's operation consistently.

When the power module 300 is connected to the commercial power 400, the power module 300 can supply electric power for the display modules 200, and the control units 230 set initial statuses of the display panels 220 respectively and then search the signal command from the receiving unit 210 and the set of synchronous transmission lines 100 periodically. When one of the control units 230 acquires the signal command, this control unit 230 resets the statuses of the corresponding display panel 220 according to the signal command, generates the power control signal to control the power module 300, and sends out the signal command through the set of synchronous transmission lines 100, so that the other display modules 200 can operates synchronously for the user's convenience. In addition, there is consistency among these display modules 200, and this system 10 has expandability.

On the contrary, when the power module 300 is disconnected from the commercial power 400, the power module 300 is incapable of supply electric power for the display modules 200, and therefore the display modules 200 are turned off, in which each control unit 230 stops searching the signal command.

For image display of the synchronous and asymmetrical display system 10, a computer or the like can be operated to sends video signals 510, 520 and 530, and the display modules 200 acquire the video signals 510, 520 and 530 respectively, so that the display panels 220 display images based on the video signals 510, 520 and 530 respectively. In practice, these video signals are equal to each other for showing the same dynamic images; alternatively, these video signals are different from each other for showing various dynamic images. Or, one or more of the video signals the same, and the other video signals are different.

The receiving unit 210 may include a wireless receiver 211. The wireless receiver 211 is electrically coupled with the control unit 230. A user may use a remote controller to send a signal command to the synchronous and asymmetrical display system 10. The wireless receiver 211 can receive the signal command. For example, the wireless receiver 211 may be an infrared receiving device, a Bluetooth receiving device or the like.

Alternatively or additionally, the receiving unit 210 may include a transmission port 212. The transmission port 212 is electrically coupled with the control unit 230. A computer or the like can be connected to the transmission port 212 of the synchronous and asymmetrical display system 10. When the computer or the like sends a signal command, the transmission port 212 can receive the signal command. For example, transmission port 212 may be a COM port, a RS-232 interface or another interface.

Alternatively or additionally, the receiving unit 210 may include a manual switch 213. The manual switch 213 is electrically coupled with the control unit 230. When a user operates the manual switch 213, the manual switch 213 is responsive to the user's operation for sending the signal command, such as the shutdown signal, a boot signal or another signal.

In addition, the control unit 230 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

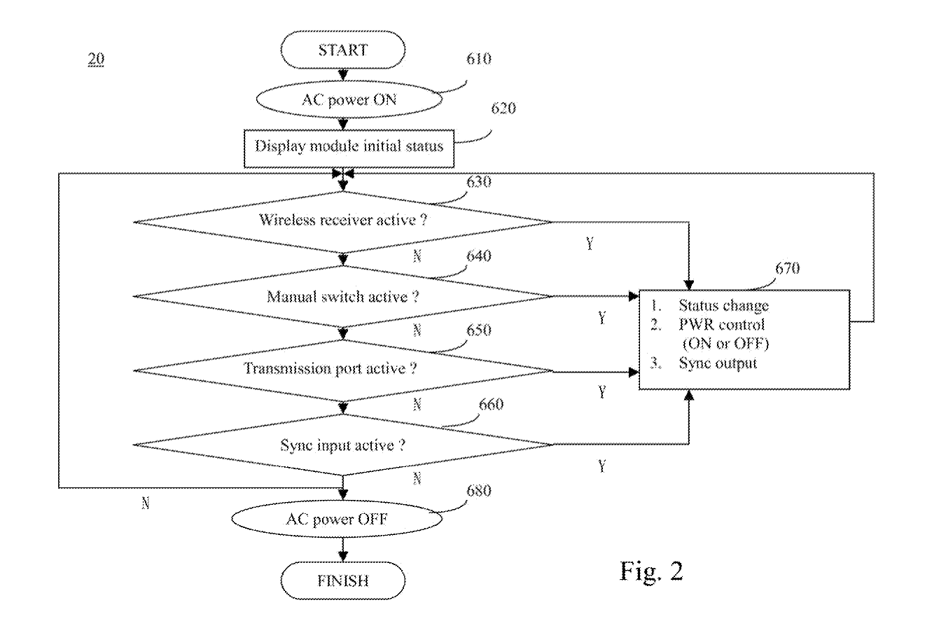

In another aspect, the present invention is directed to a method of operating a synchronous and asymmetrical display system 10. For a more complete understanding of this operating method 20, and the advantages thereof, please refer to FIG. 2 and embodiments of the present disclosure.

FIG. 2 is a flowchart of a method 20 of operating a synchronous and asymmetrical display system according to another embodiment of the present disclosure. As shown in FIG. 2, the method 20 includes steps 610-680. It should be noted that those implements to perform the steps in the method 20 are disclosed in above embodiments and, thus, are not repeated herein. The steps are not recited in the sequence in which the steps are performed. That is, unless the sequence of the steps is expressly indicated, the sequence of the steps is interchangeable, and all or part of the steps may be simultaneously, partially simultaneously, or sequentially performed.

The method 20 can be performed on any one of the display modules 200, a routine is to command each of the display modules 200 to search a signal command from its receiving unit 210 and the set of synchronous transmission lines 100. When one of the display modules 200 acquires the signal command, the signal command is transmitted to the other display modules 200 through the set of synchronous transmission lines 100, and then a power control signal is generated by one of the display modules 200 to control the power module 300. The receiving unit 210 may include the wireless receiver 211, the transmission port 212 and the manual switch 213.

Specifically, in step 610, the power module 300 is connected to the commercial power 400 (i.e., AC power). Then, in step 620, an initial status of each display module 200 is set respectively. For example, the display modules 200 can be turned on or off.

In step 630, whether the wireless receiver 211 receives the signal command is determined. When the wireless receiver 211 does not receive the signal command, whether the manual switch 213 generates the signal command is determined in step 640. When the manual switch 213 does not generate the signal command, whether the transmission port 212 receives the signal command is determined in step 650. When the transmission port 212 does not receive the signal command, whether the signal command is received from the set of synchronous transmission lines 100 is determined in step 660. When the signal command is not received, steps 630-660 may be repeated in an iterative manner. In this way, the signal command is searched from the receiving unit 210 and the set of synchronous transmission lines 100 periodically.

On the contrary, in step 670, when any one of the wireless receiver 211, the transmission port 212, the manual switch 213 and the set of synchronous transmission lines 100 gets the signal command, the status of the corresponding display module 200 is reset according the signal command, the power control signal (PWR control) is generated to control the status (ON or OFF) of the power module 300, and the signal command is outputted through the set of synchronous transmission lines 100, so that the other display modules 200 can operates synchronously. In addition, there is consistency among these display modules 200, and this system has expandability.

Moreover, in step 680, the power module 300 is disconnected from the commercial power 400; then, the method is finished.

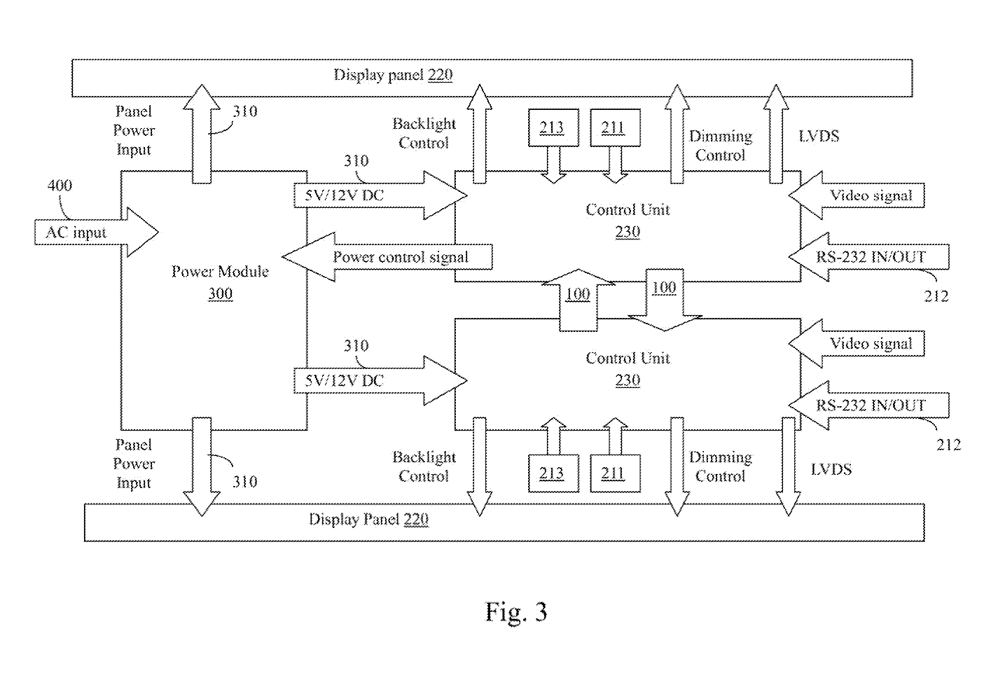

FIG. 3 is a schematic drawing of a synchronous and asymmetrical display system according to yet another embodiment of the present disclosure. As shown in FIG. 3, this synchronous and asymmetrical display system has two display panels 220, where the upper display panel 220 in FIG. 3 is named as a first display panel, and the lower display panel 220 in FIG. 3 is named as a second display panel. The first and second display panels are configured as a back-to-back device, and their screens face in opposing directions. The power module 300 may be a power board. Two control units 230 are two AD board, where the upper control unit 230 in FIG. 3 is named as a first control unit, and the lower control unit 230 in FIG. 3 is named as a second control unit.

In use, when the commercial power 400 inputs AC power to the power module 300, and the power module 300 can supply electric power for the display panels 220 via the power line 310 and further convert the AC power into DC power (e.g., 5V and/or 12V) for two control units 230. The control units 230 serves as the AD boards to output a backlight control, a dimming control, a low voltage differential signal (LVDS), another signal or the combinations thereof to the display panels 220.

In this embodiment, the two display panels 220 (i.e., the first and second display panels) can be turned on/off synchronously. When any one of the wireless receiver 211, the transmission port 212 (e.g., RS-232 interface), the manual switch 213 connected to the first display panel has a boot signal, the first display panel is turned on, the first display panel is also turned on. When a user wants to turn off the first and second display panels, it is not necessary to turn off the first display panel, he or she can turn off the second display panel, so that the first and second display panels can be turned off synchronously. The set of synchronous transmission lines 100 connects two control units 230 for the synchronous operation. When the first AD board receives the boot signal, the first AD board sends the power control signal to the power module 300, so that the power module 300 can be turned on to supply electric power. Moreover, the first AD board makes the second AD board get the synchronous boot signal through the set of synchronous transmission lines 100, without additional circuitry. In this way, malfunction cannot occur.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly status “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A synchronous and asymmetrical display system, comprising:
a set of synchronous transmission lines;
a plurality of display modules connected in series through the set of synchronous transmission lines
a single power module electrically connected to the display modules, each display module comprising:
a receiving unit;
a display panel; and
a control unit electrically connected to the display panel and the receiving unit for searching a signal command from the receiving unit and the set of synchronous transmission lines, wherein when one of the control units acquires the signal command, the one of the control units transmits the signal command to the other control units through the set of synchronous transmission lines asymmetrically, and then one of the display modules generates a power control signal to control the power module.

2. The synchronous and asymmetrical display system of claim 1, wherein when the power module is connected to a commercial power, the control units set initial statuses of the display panels respectively and then search the signal command from the receiving unit and the set of synchronous transmission lines periodically; when the power module is disconnected from the commercial power, each of the control units stops searching the signal command.

3. The synchronous and asymmetrical display system of claim 1, wherein the display modules acquire video signals respectively, so that the display panels display images based on the video signals respectively.

4. The synchronous and asymmetrical display system of claim 1, wherein the receiving unit comprises a wireless receiver for receiving the signal command.

5. The synchronous and asymmetrical display system of claim 1, wherein the receiving unit comprises a transmission port for receiving the signal command.

6. The synchronous and asymmetrical display system of claim 1, wherein the receiving unit comprises a manual switch for sending the signal command.

7. A method of operating a synchronous and asymmetrical display system that comprises a set of synchronous transmission lines, display modules and a single power module, the display modules connected in series through the set of synchronous transmission lines, the display modules comprising a receiving unit each, and the method comprising:
(a) commanding each of the display modules to search a signal command from its receiving unit and the set of synchronous transmission lines; and
(b) when one of the display modules acquires the signal command, transmitting the signal command to the other display modules through the set of synchronous transmission lines asymmetrically, and then generating a power control signal by one of the display modules to control the power module.

8. The method of claim 7, wherein step (a) comprises:
setting initial statuses of the display modules respectively when the power module is connected to a commercial power, and then using each of the display modules for searching the signal command from the receiving unit and the set of synchronous transmission lines periodically; and
stopping searching the signal command when the power module stops supplying an alternate current for the display modules.

9. The method of claim 7, further comprising:
(c) when the display modules acquire video signals respectively, displaying images based on the video signals respectively.

10. The method of claim 7, wherein the receiving unit includes a wireless receiver, a transmission port and a manual switch.
